(19) United States
(12) Patent Application Publication
(10) Pub. No.: US 2020/0226077 A1
(43) Pub. Date: Jul. 16, 2020

(54) NETWORK INTERFACE DEVICE WITH NON-VOLATILE MEMOERY EXPREESS OVER FABRICS (NVME-OF) SUPPORT OVER WIDE-AREA NETWORKS

(71) Applicant: Goke US Research Laboratory, Santa Clara, CA (US)

(72) Inventors: Xinhai Kang, Milpitas, CA (US); Engling Yeo, San Jose, CA (US)

(21) Appl. No.: 16/248,666

(22) Filed: Jan. 15, 2019

(51) Int. Cl. G06F 13/16; G06F 13/40; H04L 29/08

(52) U.S. Cl. CPC G06F 13/1668; H04L 67/1097; G06F 13/4027

(57) ABSTRACT

A system, method and apparatus for storing data from a host system to a target data storage device over a wide-area network. In one embodiment, a network interface device is described, for receiving data storage commands from a remote host system, for determining if the data storage command comprises an I/O command or an administrative command, and for sending I/O commands to a target data storage device over a local fabric network and the administrative commands to a target data storage server over the local fabric network.

### BACKGROUND

### I. Field of Use

The present invention relates to the field of digital data storage and more specifically to remote data storage over wide-area networks.

### II. Description of the Related Art

Flash memory—also known as flash storage—is a type of non-volatile memory that is gaining widespread use in enterprise storage facilities, offering very high performance levels catering to customer expectations for performance, efficiency and reduced operational costs. Such flash memory is realized as high-capacity hard drives. Several years ago, the well-known Non-Volatile Memory Express (NVMe), version 1.3 standard was released, allowing direct access to such flash memory drives directly over a PCEi serial bus. The VNMe standard version 1.3 is incorporated by reference herein in its entirety. The NVMe standard provides low-latency and parallelism of internal flash storage devices. NVMe is somewhat limited, however, due to the fact that it is intended to define interactions between a host and an NVMe “subsystem” over a local PCIe bus, making it difficult to extend its potential to different use cases. This limitation is alleviated by new technology called NVMe over fabrics or NVMe-OF.

NVMe-OF enables the use of alternate transports to PCIe to extend the distance over which an NVMe host device and an NVMe storage drive or subsystem can connect. It is a technology specification designed to enable non-volatile memory express message-based commands to transfer data between a host computer and a target solid-state storage device or system over a wide-area network, such as the Internet.

FIG. 1 is a functional block diagram of a prior art, network storage system, where a host system stores and retrieves data across a wide-area network using NVMe-OF, in this example, over the Internet utilizing remote direct memory access (RDMA). RDMA is a network transport protocol that allows remote direct memory access (RDMA) between two computing devices. Other transport protocols may be used, such as fiber channel. When writing data to the target system, as shown, an application running on the host system provides data to an NVMe host driver, where the NVMe host driver generates a command capsule containing the data, formats the command capsule in accordance with an RDMA protocol, and transports a RDMA message containing the command capsule over a local PCEi bus to a network interface card (NIC). The NIC formats the RDMA message in accordance with an Ethernet protocol and sends it to a local area network, such as an Ethernet network, which formats the RDMA message in accordance with a wide-area network protocol, such as TCP/IP. The RDMA message is received by a target NIC and then provided to the target system via a target system via a local network fabric such as PCEi, Infiniband®, iWarp, Fiber Channel, RoCE, etc. In accordance with the VNMe protocol, the data in the command capsule is stored by a target VNMe driver in a submission queue, and a response capsule is generated by the target VNMe driver and sent back to the host system, indicating successful receipt of the command capsule.

Next, the host VNMe driver in the target system generates a local command capsule containing the data, and sends the local command capsule to one of several solid state drives (SSDs) coupled locally to the target system via the local network fabric. Thus, data sent from the host system to the remote SSDs must be received by the target system's NVMe driver and then re-encapsulated in order to send the data to a particular, locally-connected SSD. This causes increased storage and retrieval latencies.

It would be desirable to improve the prior art storage systems to reduce the latencies caused by re-encapsulation of data by the target system.

### SUMMARY

The embodiments herein describe systems, methods and apparatus for storing data from a host system to a target data storage device over a wide-area network. In one embodiment, a network interface device is described, coupled to a target data storage server and to a plurality of data storage devices, for storing data received from a host system over a wide-area network, comprising a network interface for receiving data storage commands from the host system over the wide-area network, a fabric interface coupled to the target data storage server and to the plurality of data storage devices via a local network fabric, a memory for storing processor-executable instructions, a processor, coupled to the network interface, the fabric interface and the memory, for executing the processor-executable instructions that causes the network interface device to receive, by the network interface, a first data storage command from the host system over the wide-area network, determine, by the processor, that the first data storage command comprises an I/O command, forward, by the processor via the fabric interface, the I/O command to a first data storage device of the plurality of data storage devices when the processor determines that the first data storage command comprises an I/O command.

In another embodiment, a method is described, performed by a network interface device, comprising receiving, by a network interface, a first data storage command from the host system over the wide-area network, determining, by the processor, that the first data storage command comprises an I/O command, and providing, by the processor via a fabric interface, the I/O command to a first data storage device of the plurality of data storage devices over the local network fabric when the processor determines that the first data storage command comprises an I/O command.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a conceptual diagram of a prior art storage and retrieval system;

FIG. 2 illustrates a conceptual diagram of one embodiment of a storage and retrieval system in accordance with the teachings herein;

FIG. 3 is a conceptual diagram of a prior art target network interface device as shown in FIG. 1;

FIG. 4 is a conceptual diagram of the target network interface device as shown in FIG. 2;

FIG. 5 is a simplified functional block diagram of the target network interface device as shown in FIGS. 2 and 4;

FIG. 6 is a simplified functional block diagram of one embodiment of a host system as shown in FIGS. 1 and 2;

FIG. 7 is a simplified functional block diagram of one embodiment of a target system as shown in FIGS. 1 and 2;

FIG. 8 is a simplified functional block diagram of one embodiment of a data storage device as shown in FIGS. 1 and 2;

FIGS. 9A and 9B are flow diagrams illustrating one embodiment of a method, or algorithm, for storing data from the host system shown in FIG. 2 to a data storage device as shown in FIG. 2; and

FIGS. 10A and 10B are flow diagrams illustrating one embodiment of a method, or algorithm, for retrieving data from the data storage device as shown in FIG. 2 by the host system shown in FIG. 2.

### DETAILED DESCRIPTION

Systems, methods and apparatus are described for storing data in a remote storage device over a wide-area network. In one embodiment, a host system, such as a computer system, interacts with a target system over the wide-area network, the target system comprising a server located at an enterprise data storage facility, coupled to one or more high-capacity data storage devices. In general, the host system sends data to the target system for storage on the one or more high-capacity data storage devices. Unlike the prior art, however, data is stored and retrieved directly between the host system and the data storage devices, without intervention from the target system. This improves the performance of such remote data storage systems, because it eliminates the processing delays normally encountered as data travels through the target system during remote read and write operations issued by the host system. This dramatically reduces read and write latencies.

In the description that follows, certain aspects and embodiments of the invention may be applied independently and some of them may be applied in combination as would be apparent to those of skill in the art. For the purposes of explanation, specific details are set forth in order to provide a thorough understanding of embodiments of the invention.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the embodiments as set forth in the appended claims.

Although specific details are given to provide a thorough understanding of at least one embodiment, it will be understood by one of ordinary skill in the art that some of the embodiments may be practiced without disclosure of these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a method, a process or an algorithm performed by a processor, which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure.

The terms “computer-readable medium”, “memory”, “storage medium”, and “data storage device” includes, but is not limited to, portable or non-portable electronic data storage devices, optical storage devices, and various other mediums capable of storing, containing, or carrying instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, RAM, ROM, flash memory, solid state disk drives (SSD), etc. A computer-readable medium or the like may have stored thereon code and/or processor-executable instructions that may represent a method, algorithm, procedure, function, subprogram, program, routine, subroutine, or any combination of instructions, data structures, or program statements.

Furthermore, embodiments may be implemented by hardware, software, firmware, middleware, microcode, hardware description languages, or any combination thereof. When implemented in software, firmware, middleware or microcode, the program code, i.e., “processor-executable code”, or code symbols to perform the necessary tasks (e.g., a computer-program product) may be stored in a computer-readable or machine-readable medium. A processor(s) may perform the necessary tasks.

The embodiments described herein provide specific improvements to a networked, data storage and retrieval system. For example, the embodiments allow such a data storage system to store and retrieve data faster than prior art systems.

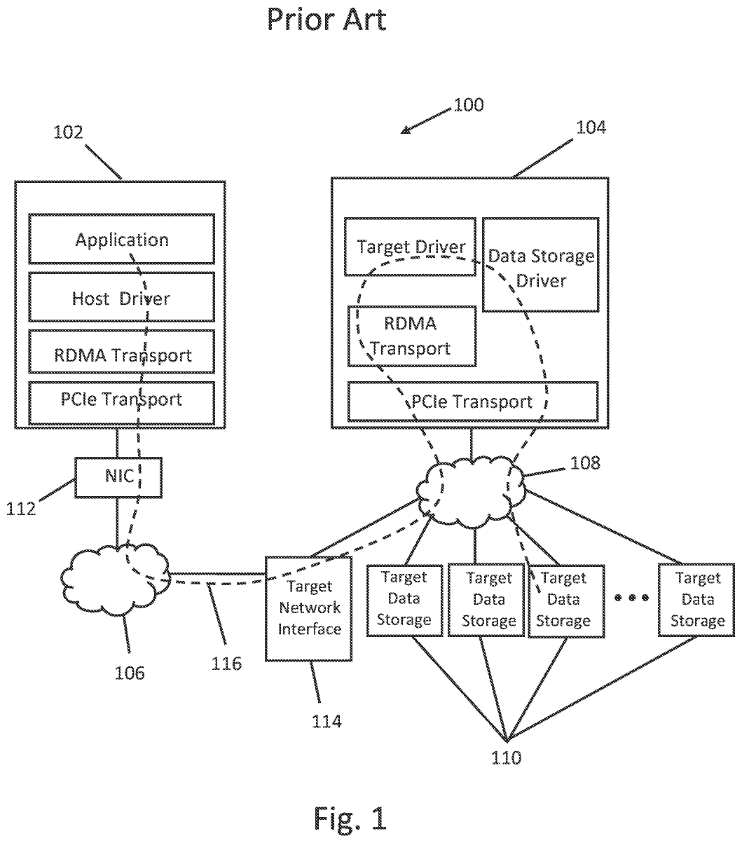

FIG. 1 illustrates a conceptual block diagram of a prior art networked storage system 100. Host system 102 stores and retrieves data to and from target system 104 over wide-area network 106. Host system 102 may comprise a desktop computer, a server, a mobile device such as a laptop or tablet computer, smart phone, wearable device, camera or some other digital electronic device that stores or retrieves data. Host system 102 comprises a host network interface device 112 for routing data between host system 102 and target system 104, such as a popular network interface card (NIC) that is installed into target system 104 and routes traffic to a local-area Ethernet-based wireless network. Target system 104 typically comprises one or more network servers for storing large volumes of data for multiple host systems over wide-area network 106, such as in an enterprise storage area network (SAN) which provides access to consolidated, block level data storage. SANs are primarily used to enhance accessibility of storage devices, such as disk arrays and tape libraries, accessible to servers remote host systems so that the storage devices appear to the operating system as locally-attached devices.

Target system 104 may comprise local fabric 108, which comprises a data bus, switching circuitry and protocols for routing data between target network interface device 114 and target system 104, and between target system 104 and one or more data storage devices 110. Examples of local fabric 108 comprise Fiber Channel, Infiniband® and RoCE. Examples of target network interface device 114 include an Ethernet NIC or a dedicated, stand-alone device specially configured to send and receive traffic for target system 104 over local fabric 108.

FIG. 1 additionally shows a path 116 of how data is generated by an application resident on host system 102 and stored across wide-area network 106 to one of the data storage devices 110. The application, such as word processing software, image generation software (as used in a digital camera), or, in general, enterprise software (i.e., applications for managing a business's general data storage needs). The application provides the data to a data storage host driver, in one embodiment, a non-volatile memory express (NVMe) host driver, which provides an interface to a particular hardware device, in this case, the data storage devices 110 coupled to target system 104.

In one embodiment, the data storage driver then provides the data to a remote direct memory access (RDMA) transport layer, which is normally used to allow the data to be stored and retrieved directly with the target system without involving either a host CPU or a target CPU. Network protocols that support RDMA include Infiniband®, iWarp and RoCE.

Next, the data is provided to a host bus transport layer that allows the data to be transported to host network interface device 112. Host network interface device 112 then encapsulates the data in accordance a wide-area network protocol, such as TCP/IP, and sends the data across wide-area network 106 to an IP address associated with target system 104.

The encapsulated data is received by target network interface device 114, where the data is unencapsulated and provided to target system 104 via local fabric 108. The data is received by a target local fabric transport layer, and then processed by, in some embodiments, a target system RDMA layer where the data is recovered in its original form. Finally, the data is received by a target system data driver, where it is stored in buffer memory or a memory of target system 104.

The target data storage driver next sends the data to a data storage driver within target system 104 to a data bus transport layer, in one embodiment, a PCIe transport layer. The PCIe transport layer provides the data to one of the data storage devices 110 via local fabric 108.

Read operations from host system 102 operate in a similar fashion, with read commands sent by host system 102 over wide-area network 106 and received, ultimately, by the target data driver, and then the target data storage driver retrieves the data from one of the data storage devices 110 via the local fabric 108. The retrieved data is then provided to the target system data driver, which sends the retrieved data to host system 102 via target network interface device 114 and wide-area network 106.

Thus, for write operations, data is sent from host system 102 over wide-area network 106, and provided to target system 102, where it is then re-processed in order to store it on one of the data storage devices 110. For read operations, data is retrieved by target system 104 and then re-processed in order to provide it to host system 202 via target network interface device 114 and wide-area network 106. This extra re-processing introduces unwanted delays in read and write operations.

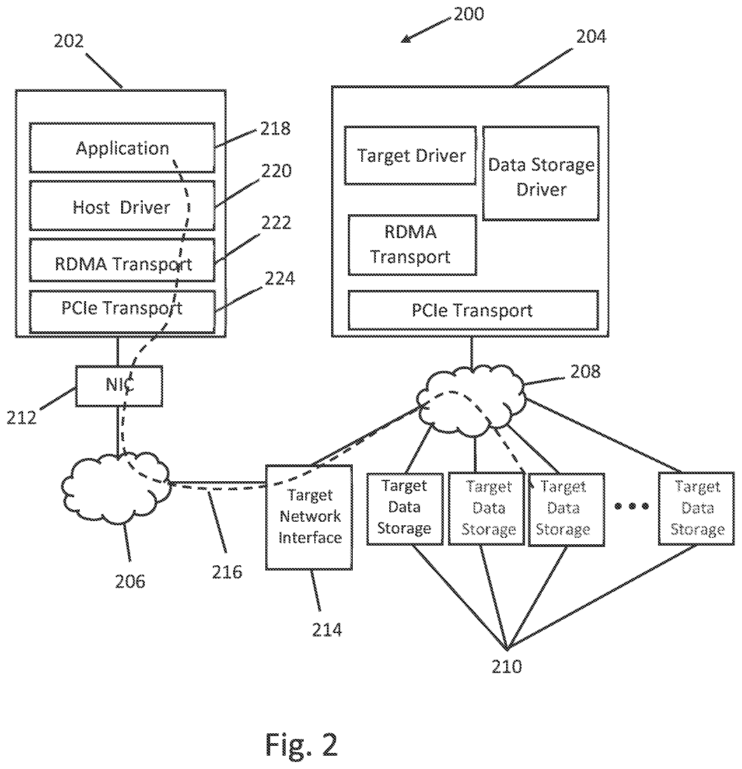

FIG. 2 illustrates a conceptual diagram of one embodiment of a networked storage system 200 in accordance with one embodiment of the present invention, with the components having similar functionalities and structure as those shown in FIG. 1, except as otherwise noted herein. As in FIG. 1, target storage server 204 stores large volumes of data in one or more data storage devices 210 across wide-area network 206, for example in an application such as a remote storage area network (SAN). However, data to and from host system 202 is not processed by target storage server 204. Rather, data is sent directly between data storage devices 210. This avoids the delays associated with routing data through target storage server 204.

FIG. 2 illustrates a data path 216, showing how data is generated by host system 202 and stored across wide-area network 206 to one of the data storage devices 210. As before, host system 202 executes one or more applications 218, such as word processing software, image generation software (as used in a digital camera), or, in general, enterprise software (i.e., applications for managing a business's general data storage needs). The application(s) provides the data to a data storage host driver 218, in one embodiment, a non-volatile memory express (NVMe) or an NVMe over fabric (NVMe-oF) host driver, which provides an interface to a particular hardware device over wide-area network 206, in this case, the data storage devices 210 coupled to target storage server 204. The term “fabric” is used to denote the hardware, switches and protocols used to transport data from one point to another.

In one embodiment, the data storage driver 220 may then provide the data to a remote direct memory access (RDMA) transport layer 222, which is used to transport I/O, administrative and, in some cases, fiber channel commands data to target network interface device 214. Network protocols that support RDMA include Infiniband®, iWarp and RoCE.

Next, the data is provided to a host bus transport layer 224 that allows the data to be transported to host network interface device 212 via a standardized protocol, such as PCIe, SATA, SATEe, SAS, eMMC, UFS, PCI, PCI-X, USB, etc. Host network interface device 212 then encapsulates the data in accordance a wide-area network protocol, such as an IP protocol such as TCP/IP, and sends the data across wide-area network 206 to an IP address associated with target storage server 204.

The encapsulated data is received by target network interface device 214. Target network interface device 214 comprises hardware and firmware to send and receive encapsulated data to and from host system 202 via wide-area network 206. It additionally comprises processor-executable instructions to determine if received messages comprise I/O commands and/or data, and if so, route the I/O commands and/or data to one or more data storage devices 210 directly via local fabric 208. I/O commands are commands sent by host system 202 to store or retrieve data from one of the data storage devices 210, or to erase all or a portion of one or more data storage devices. In one embodiment, the I/O commands comprise an I/O write command, for storing data, an I/O read command, for retrieving data, and an I/O erase command, for erasing data. Examples of target network interface device 214 include an Ethernet, Infiniband® or Fiber Channel network interface device having such data routing capabilities.

Read operations from host system 202 operate in a similar fashion, with I/O read commands sent by host system 202 over wide-area network 206 and received by target network interface device 214. Target network interface device 214 un-encapsulates received messages, determines if the message(s) is/are an I/O read command and, if so, retrieves data from one of the data storage devices 210 directly via local fabric 208. The retrieved data is then provided to wide-area network 206 and forwarded to host system 202.

Thus, for write operations, data is sent over wide-area network 206 and provided to one of the data storage devices 210 directly by target network interface device 214, thus avoiding delays in sending the data to host system 204. For read operations, data is retrieved by target network interface device 214 directly from one of the data storage devices 210, again avoiding delays in sending retrieve commands to host system 204 and having hast system 204 process the command.

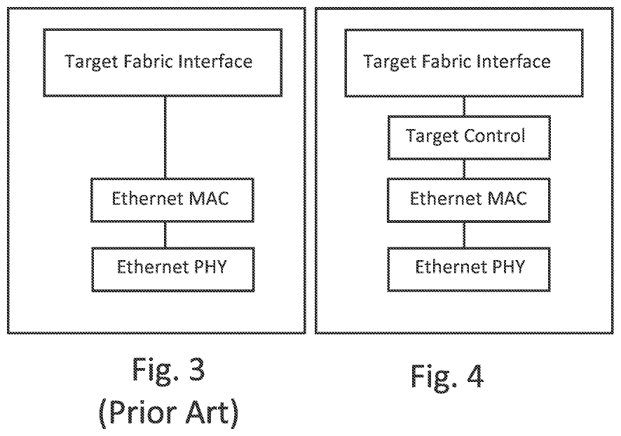

FIG. 3 is a conceptual diagram of a prior art target network interface device and FIG. 4 is a conceptual diagram of target network interface device 214 in accordance with the inventive concepts discussed herein. In FIG. 3, data packets are received by the prior art target network interface device from host system 102 by, in one embodiment, an Ethernet physical layer, which comprises hardware and protocols to receive data packets in accordance with one or more particular data protocols, such as TCP/IP. The Ethernet Mac layer provides an addressing mechanism and channel access so that each “node” on local fabric 108 can communicate with other nodes available on the same or other fabrics. The un-encapsulated data is appended with a unique MAC address by the Ethernet MAC layer, and the resulting data provided to data bus interface circuitry, which provides the data to target storage server 204.

Target network interface device 214, on the other hand, also receives data packets, from host system 202, and provides un-encapsulated data to the MAC layer, where a MAC address of target network interface device 214 is added. However, target network interface device 214 further comprises target control logic to determine whether the un-encapsulated data is an I/O command and/or data, or whether the un-encapsulated data is an administrative command or, in one embodiment, a fabric command as defined by the document “NVM Express over Fabrics, Revision 1.0” dated Jun. 5, 2016, published by NVM Express, Inc., incorporated by reference herein in its entirety. Administrative commands comprise, for example, commands to identify data storage devices 210 coupled to target data storage server 204, get or set features of the data storage devices, an abort command, a firmware image download command, a firmware activate command, or one or more vendor specific commands. If the un-encapsulated data comprises an I/O command, i.e., a command to store or retrieve data, or data itself, the target control logic routes the I/O command, or data to be stored, to one of the data storage devices 210, as specified in the I/O command or data to be stored. If the un-encapsulated data is not an I/O command, or data to be stored, the target control logic routes the command to target storage server 204 via the fabric interface for further processing by target storage server 204.

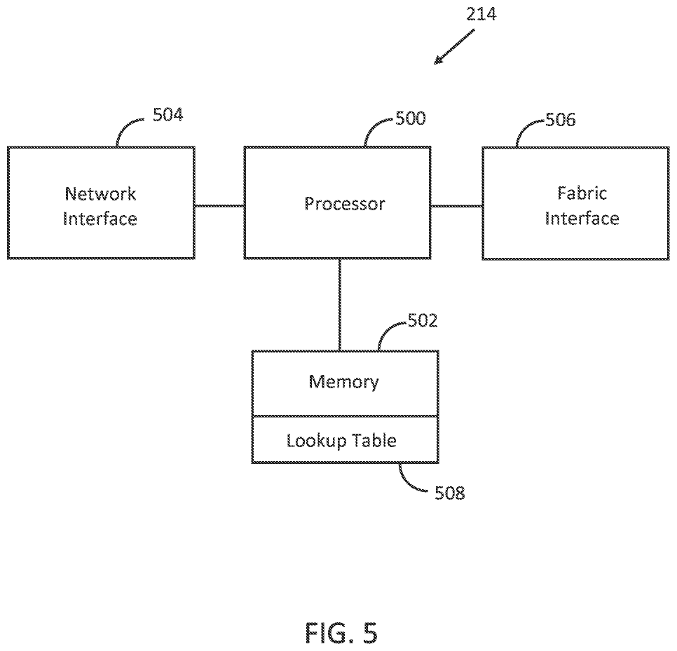

FIG. 5 is a simplified functional block diagram of target network interface device 214. Target network interface device 214 comprises processor 500, memory 502, network interface 504 and fabric interface 506.

Processor 500 is configured to provide general operation of target network interface device 214 by executing processor-executable instructions stored in memory 502, for example, executable computer code. Processor 500 typically comprises one or more general or specialized microprocessors, microcontrollers, and/or customized ASICs, selected based on computational speed, cost, power consumption, and other factors relevant to a network interface device.

Memory 502 is coupled to processor 500 and comprises one or more non-transitory information storage devices, such as RAM, ROM, flash memory, or other type of electronic, optical, or mechanical memory device. Memory 502 is used to store processor-executable instructions for operation of target network interface device 214. It should be understood that in some embodiments, a portion of memory 502 may be embedded into processor 500 and, further, that host memory 502 excludes media for propagating signals.

Network interface 504 is coupled to processor 500, comprising circuitry for sending and receiving data storage commands and data to/from host system 202 over wide-area network 206, typically via a local-area network co-located with target storage server 204, such as a local Ethernet network.

Fabric interface 506 is coupled to processor 500, comprising well-known circuitry for sending administrative and fabric commands to target storage server 204, and I/O commands and data to/from one or more data storage devices 210 over local fabric 208. Fabric interface 506 may also be configured to receive administrative and fabric responses from target storage server 204, and I/O responses from the one or more data storage devices 210. Such circuitry utilizes one of a number of well-known data protocols, such as Fiber Channel, RoCE, Infiniband®, iWarp, or others.

Each of the data storage devices 210 comprises one or more Solid State Drives (SSDs), magnetic hard drives, magnetic tape drives, or some other high-capacity storage mediums. Such data storage devices typically comprise a controller configured in accordance with a particular data transfer protocol used by local fabric 208.

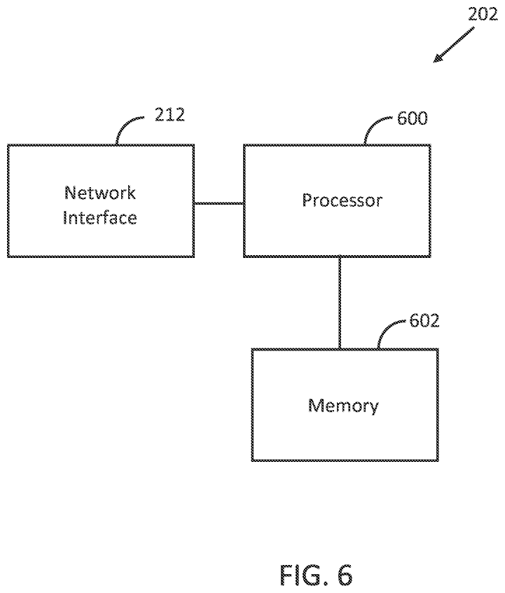

FIG. 6 is a simplified functional block diagram of one embodiment of host system 202, comprising host processor 600, memory 602, and network interface 212.

Host processor 600 is configured to provide general operation of host system 202 by executing processor-executable instructions stored in memory 602, for example, executable computer code. Host processor 600 typically comprises one or more general or specialized microprocessors, microcontrollers, and/or customized ASICs, selected based on computational speed, cost, power consumption, and other factors.

Host memory 602 is coupled to host processor 600 and comprises one or more non-transitory information storage devices, such as RAM, ROM, flash memory, or other type of electronic, optical, or mechanical memory device. Memory 602 is used to store processor-executable instructions for operation of host system 202. It should be understood that in some embodiments, a portion of memory 602 may be embedded into host processor 600 and, further, that host memory 602 excludes media for propagating signals.

Network interface 212 is coupled to host processor 600, comprising circuitry for sending and receiving data over wide-area network 206, typically via a local data network serving host computer 202.

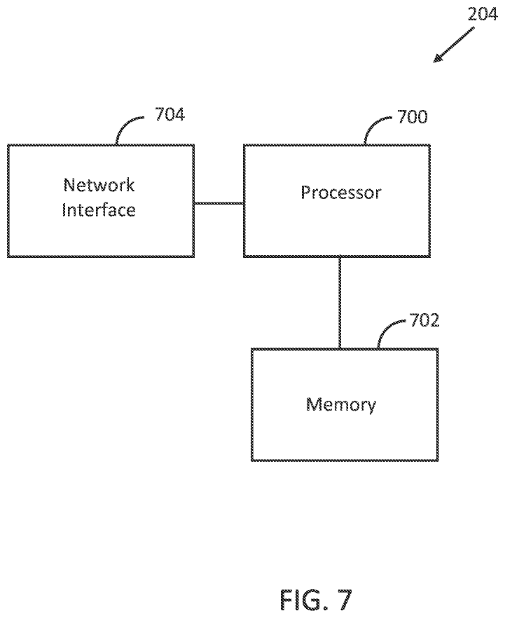

FIG. 7 is a simplified functional block diagram of one embodiment of target storage server 204, comprising target processor 700, target memory 702, and fabric interface 704.

Target processor 700 is configured to provide general operation of target storage server 204 by executing processor-executable instructions stored in memory 702, for example, executable computer code. Target processor 700 typically comprises one or more general or specialized microprocessors, microcontrollers and/or customized ASICs, selected based on computational speed, cost, power consumption, and other factors, suitable for modern, cloud-based servers or enterprise data storage centers.

Target memory 702 is coupled to target processor 700 and comprises one or more non-transitory information storage devices, such as RAM, ROM, flash memory, or other type of electronic, optical, or mechanical memory device. Target memory 702 is used to store processor-executable instructions for operation of target storage server 204. It should be understood that in some embodiments, a portion of target memory 702 may be embedded into target processor 700 and, further, that target memory 702 excludes media for propagating signals.

Fabric interface 704 is coupled to target processor 700, comprising circuitry for receiving administrative and, in some embodiments, fabric commands from target network interface device 214 over local fabric 208, as well as for sending responses to the administrative and/or fabric commands. Fabric interface 704 may comprise well-known circuitry that supports such fabric protocols such as iWarp, Infiniban®, and RoCE.

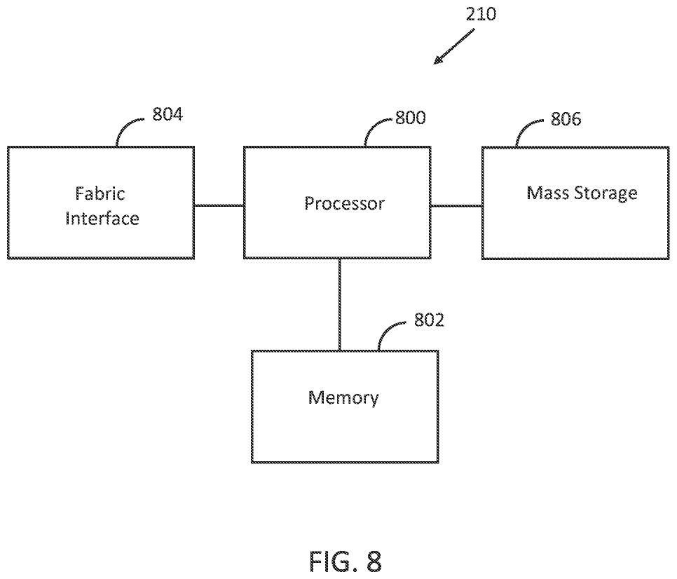

FIG. 8 is a simplified functional block diagram of one embodiment of a data storage device 210, comprising data storage controller 800, memory 802, and fabric interface 804.

Data storage controller 800 is configured to provide general operation of data storage device 210 by executing processor-executable instructions stored in memory 802, for example, executable computer code. Processor 800 typically comprises one or more general or specialized microprocessors, microcontrollers and/or customized ASICs, selected based on computational speed, cost, power consumption, and other factors, suitable for a high-capacity data storage device.

Memory 802 is coupled to data storage controller 800 and comprises one or more non-transitory information storage devices, such as RAM, ROM, flash memory, or other type of electronic, optical, or mechanical memory device. Memory 802 is used to store processor-executable instructions for operation of data storage device 210. It should be understood that in some embodiments, a portion of memory 802 may be embedded into data storage controller 800 and, further, that memory 802 excludes media for propagating signals.

Fabric interface 804 is coupled to data storage controller 800, comprising circuitry for receiving I/O commands and data from target network interface device 214 and providing responses to the I/O commands over local fabric 208. Fabric interface 804 may comprise well-known circuitry that supports such fabric protocols such as iWarp, Infiniban®, and RoCE.

Mass storage 806 is coupled to data storage controller 800 for storing large amounts of data from host system 102. Mass storage 806 typically comprises one or more electronic memory devices, such as one or more Flash memory banks, optical storage devices, or magnetic storage devices, as is well-known in the art. Mass storage 806 excludes media for propagating signals.

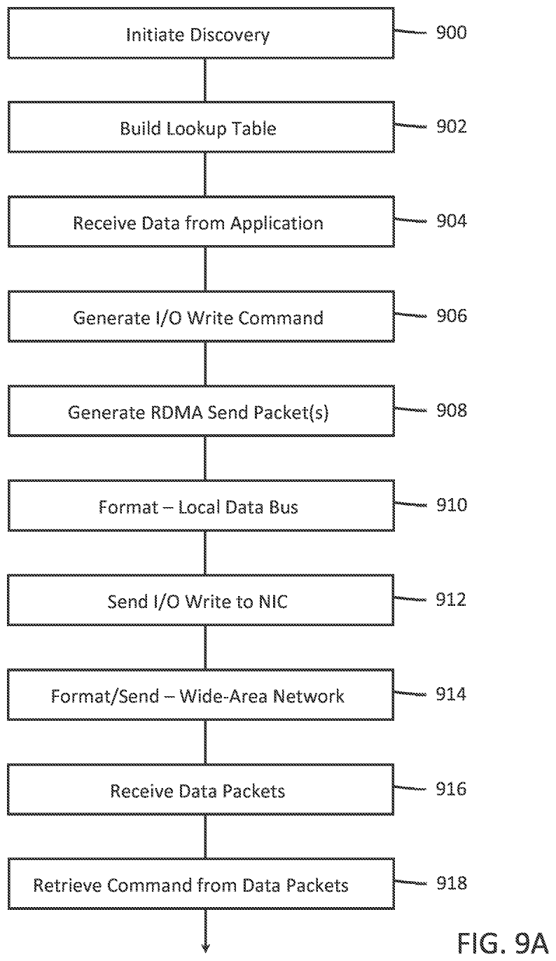

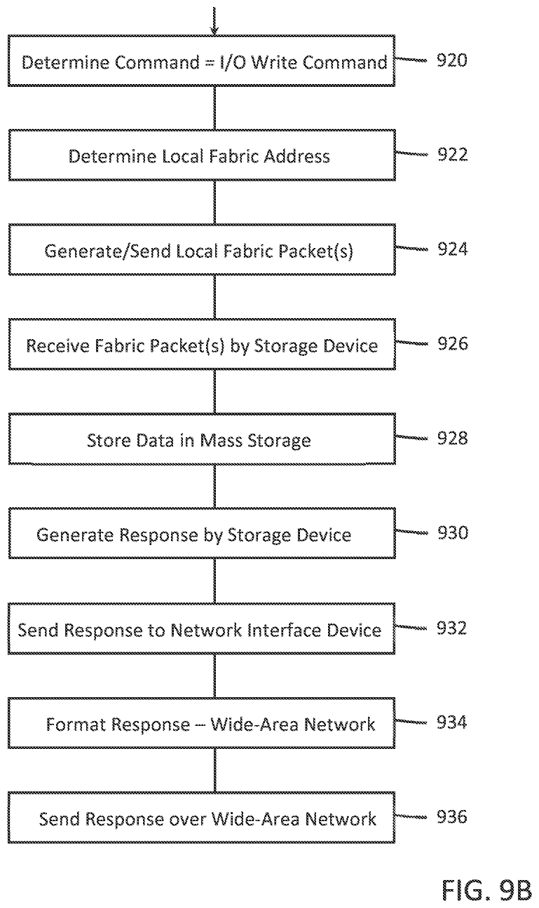

FIGS. 9A and 9B are flow diagrams illustrating one embodiment of a method, or algorithm, for storing data from host system 202 to a data storage device 210 coupled to host system 204 and target network interface device 214 via local fabric 208. More specifically, the method describes interactions between host system 202, target network interface device 214 and one of the data storage devices 210 and, even more specifically, operations performed by host processor 600, processor 500 and data storage controller 800, respectively, each executing processor-executable instructions stored in host memory 602, target network interface device memory 502 and data storage device memory 802, respectively. It should be understood that in some embodiments, not all of the steps shown in FIG. 9 are performed, and that the order in which the steps are carried out may be different in other embodiments. It should be further understood that some minor method steps have been omitted for purposes of clarity.

At block 900, host processor 600 of host system 202 initiates a discovery process to determine what storage is available to host system 202 at target storage server 204. In one embodiment, an administrative discovery query is generated by host processor 600 and sent over wide-area network 206 to host system 204 where it is received by target network interface device 214. Target network interface device 214 determines that the query comprises a discovery, or “identify” request and, in response, routes the discovery request to target data storage server 204. In another embodiment, the discovery query may be sent to a separate discovery controller coupled to local fabric 208, or at some other location, coupled to wide-area network 206. Target processor 702, or a discovery server, in response, sends an identification of some or all data storage devices 210, or partitions (i.e., storage space), thereof, managed by target storage server 204 and available to host system 202 for data storage. In one embodiment, the discovery process comprises the well-known Internet Storage Name Service (iSNS). In another embodiment, the discovery process comprises a protocol in accordance with the well-known NVM Express over Fabrics, Revision 1.0 standard. In yet another embodiment, the discovery process is performed in accordance with a fiber channel discovery protocol, as is well-known in the art. In any case, host processor 600 receives an identification of each data storage device 210, or partitions thereof, coupled to target storage server 204 that host system 202 has access to. The identification may comprise one or more local or wide-area IP addresses, Local ID (LID, as used in Infiniband®) addresses, namespace IDs (as defined in the VNMe standard version 1.3 and NVM Express over Fabrics, Revision 1.0 standards), and/or some other unique identifier. Process 600 may store the identification of each data storage device 210 in memory 602.

At block 902, target processor 500 may build a lookup table 508, stored in memory 502, comprising a list of data storage space identifiers, such as data storage devices 210 and/or partitions thereof, each paired with a local fabric address on local fabric 208. In one embodiment, this information is provided as a result of processor 500 initiating a discovery request, similar to the process described above. In response, target processor 702 sends an identification of some or all data storage devices 210, or partitions thereof, managed by target storage server 204, and an identification, or address, where each data storage device 210, or portions thereof, is located on local fabric 208. In another embodiment, the lookup table 508 is constructed as host processor 202 performs the discovery process. In this embodiment, processor 500 inspects each message originating from target storage server 204 as it is being sent to host system 202 after a discovery request has been forwarded to target storage server 204 by target network interface device 214. Target storage server 204 responds to a discovery request by sending identification and/or local fabric address information of all of the data storage devices 210 coupled to local fabric 208, and/or partitions thereof, to host system 202. When processor 500 identifies a message comprising such identity/address information form target storage server 204, the identify and/or address information is copied into the lookup table 508 and stored in memory 502.

At block 904, host processor 600 receives information from an application 218 executed by host system 202 for storage to one of the data storage devices 210.

At block 906, host processor 600 generates one or more I/O write commands to store the data received from the application to one of the selected data storage devices 210. The one or more I/O write commands comprise an identification of target storage server 204, and/or an identification of a particular data storage device 210, or partition thereof (such as a namespace ID as used in the NVMe protocol), coupled to target storage server 204. In some embodiments, each I/O write command additionally comprises some or all of the data to be stored in data storage device 210. In other embodiments, one or more identifiers are inserted into the I/O write command, such as a scatter gather list (SGL), identifying one or more locations in host memory 602 where a selected data storage device 210 may find the data to be transferred. In one embodiment utilizing the NVMe-OF protocol, each I/O write command comprises a command capsule that is stored into one or more I/O submission queues in memory 602, and, in some embodiments, some or all of the data to be stored. With reference to FIG. 2, the command capsule formation is performed by an NVMe host driver 220, which may utilize a different processor and memory than host processor 600 and memory 602. The I/O command may further comprise an identification, or address, of target storage server 204.

At block 908, in one embodiment, host processor 600 may generate an RDMA_SEND message comprising the I/O write command in accordance with the well-known RDMA protocol, where the I/O write command. The RDMA message may then be placed into an RDMA send queue.

At block 910, the I/O write command, or the RDMA_SEND message, may be formatted in accordance with a data bus protocol, for sending the I/O write command, or the RDMA_SEND message, to host network interface device 212. Such data base protocols include, but are not limited to, PCIe, SATA, SATEe, SAS, eMMC, UFS, PCI, PCI-X, or USB.

At block 912, the I/O write command, or the RDMA_SEND message, is provided to host network interface device 212 via a local data bus.

At block 914, the I/O write command, or the RDMA_SEND message, is formatted into one or more data packets by host network interface device 212 in accordance with a wide-area network protocol, such as TCP/IP. The one or more data packets are then sent by host network interface device 212 to target network interface device 214 over wide-area network 206. It should be understood that, typically, the I/O write command, or the RDMA_SEND message, is provided from host network interface device 212 to a local-area network that serves host system 202, and the local-area network provides the I/O write command, or the RDMA_SEND message, to wide-area network 206.

At block 916, the one or more data packets are received by target network interface device 214 via network interface 504. It should be understood that, in some embodiment, the data packets are first received by a local-area network that serves target storage server 204, and then the local-area network provides the data packets to target network interface device 214 via network interface 504.

At block 918, processor 500 of target network interface device 214 retrieves the I/O write command from the data packets by unpacking the one or more data packets in accordance with the wide-area network protocol and, in some embodiments, with the RDMA protocol.

At block 920, processor 500 determines that the data packets comprise an I/O write command by comparing a portion of the received command with a number of commands stored in memory 502. The number of commands may comprise an I/O write command, an I/O read command, an I/O erase command, one of a number of administrative commands, and one of a number of fabric commands. In one embodiment, processor 500 may determine that the received command is data destined for one of the data storage devices 210.

At block 922, when processor 500 determines that the data packets comprise an I/O write command, processor 500 determines a local fabric address of the selected data storage device 210 on local fabric 208 based on the identification of the selected data storage device 210 and/or partition information identified by processor 500 in the received I/O write command. In one embodiment, a lookup table 508 is maintained by processor 500 and stored in memory 502. The lookup table 508 comprises a list of data storage devices 210, and/or partitions thereof, each paired with a network address on local fabric 208.

At block 924, processor 500 generates one or more local fabric data packets representing the I/O write command, including any data to be stored, for transmission over local fabric 208 by fabric interface 506 in accordance with the protocol of local fabric 208. In another embodiment, the local fabric data packets comprise an identification of one or more locations in host memory 602 (such as a scatter gather list or SGL) where a particular data storage device 210 may find the data to be transferred. Such local fabric protocols include, but are not limited to, RoCE, Infiniband® and iWarp. The local fabric data packets each comprise the local fabric address associated with the particular data storage device 210 as determined by processor 500 via the I/O read command and lookup table 508. In some embodiments, an address of host system 202 is also provided in the local fabric data packets.

At block 926, one of the data storage devices 210 receives the one or more local fabric data packets via local fabric 208 and fabric interface 804.

At block 928, data storage controller 800 within the particular data storage device 210 unpacks the one or more local fabric data packets to retrieve the I/O command and, in some embodiments, data for storage. In one embodiment, data storage controller 800 also unpacks the command in accordance with the RDMA protocol. In one embodiment, data storage controller 800 then causes the data in the I/O command to be stored in mass storage 806, using techniques well known in the art. Mass storage 806 generally comprises one or more magnetic disks or tapes, optical storage media, flash memory, etc.

At block 930, data storage controller 800 may generate a response to the received I/O write command. The response comprises an indication of whether the data was successfully stored in mass storage 806 or not, and an identification of the data storage device 210 and/or partition where the data was, or was not, stored. In one embodiment, the response comprises a response capsule, as defined by the NVM Express over Fabrics, Revision 1.0″ dated Jun. 5. The response is generally formed into a local area data packet in accordance with a local fabric protocol and, in some embodiments, with the RDMA protocol.

In one embodiment, where an identification of one or more locations in host memory 202 is included in the local fabric data packet(s), the response comprises retrieving data from host memory 202 using the one or more locations in host memory provided in the local fabric data packet(s).

At block 932, data storage controller 800 causes the response to be sent to target network interface device 214 via fabric interface 804 and local fabric 208.

At block 934, processor 500 within target network interface device 214 receives the response via fabric interface 506 and formats it into one or more data packets suitable for transmission over wide-area network 206, in accordance with an address provided in the response by target storage server 204.

At block 936, processor 500 sends the one or more data packets to host system 202 via network interface 504 and wide-area network 206, providing an indication to host system 202 that the data was, or was not, successfully stored.

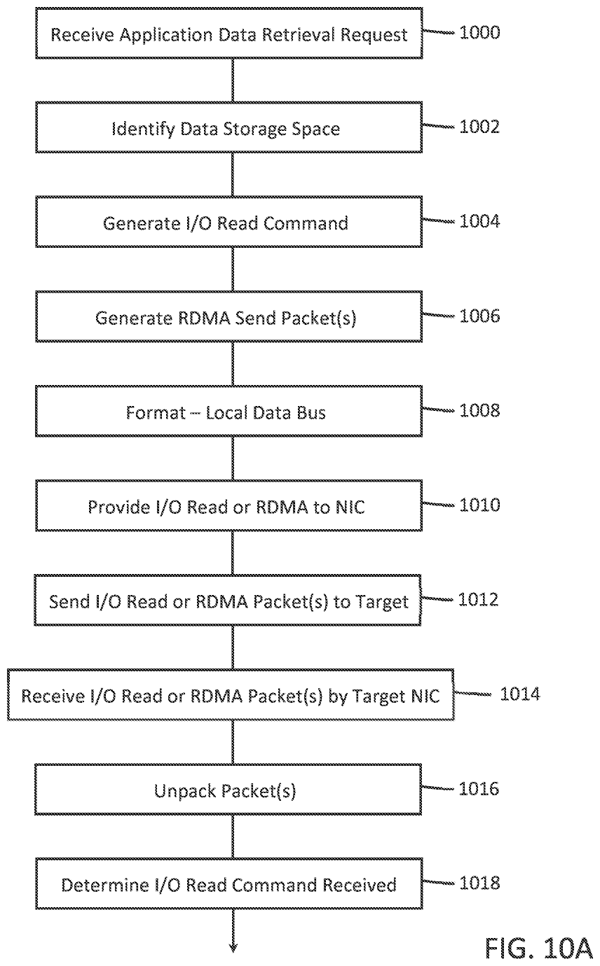

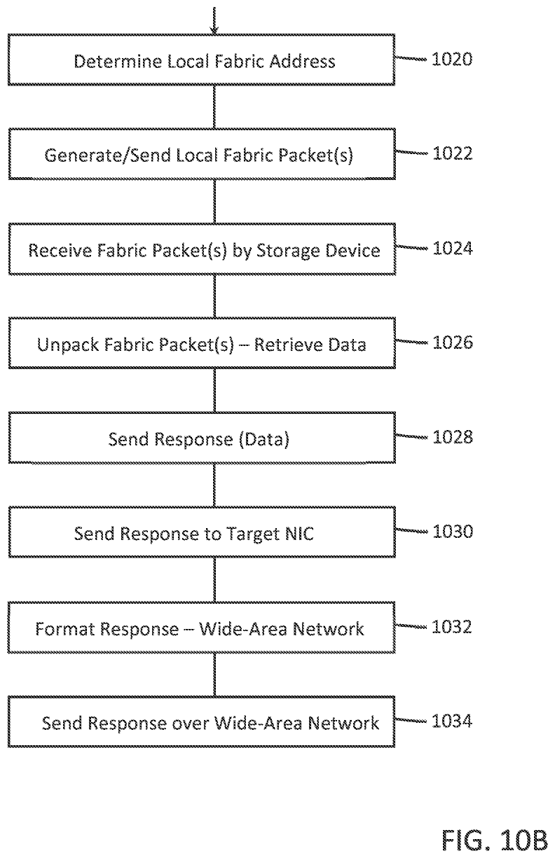

FIGS. 10A and 10B are flow diagrams illustrating one embodiment of a method, or algorithm, for retrieving data from data storage device 210 by host system 202. More specifically, the method describes interactions between host system 202, target network interface device 214 and one of the data storage devices 210 and, even more specifically, operations performed by host processor 600, processor 500 and data storage controller 800, respectively, each executing processor-executable instructions stored in host memory 602, target network interface device memory 502 and data storage device memory 802, respectively. It should be understood that in some embodiments, not all of the steps shown in FIG. 10 are performed, and that the order in which the steps are carried out may be different in other embodiments. It should be further understood that some minor method steps have been omitted for purposes of clarity.

At block 1000, host processor 600 receives a request to retrieve data from an application executed by host system 202.

At block 1002, host processor 600 identifies one of the data storage devices 210, or a partition on one of the data storage devices, where the data has been previously stored by host system 202. Such techniques are well-known in the art.

At block 1004, host processor 600 generates one or more I/O read commands to retrieve the data requested by the application. The one or more I/O read commands comprise an identification of a particular data storage device 210 and/or a particular partition in one of the data storage devices 210 where the data was previously stored, such as a local or wide-area IP address identifying a data storage device 210, or partition thereof. In one embodiment, an I/O read command comprises a namespace ID as used in the NVMe protocol. In some embodiments, a memory start address, an offset, and/or a size of the data is also provided for identifying the data within one of the data storage devices 210. In one embodiment utilizing the NVMe-OF protocol, the I/O read command(s) comprise a command capsule that is stored into one or more I/O submission queues in memory 602. With reference to FIG. 2, the command capsule formation is performed by an NVMe host driver 220, which may utilize a different processor and memory than host processor 600 and memory 602.

At block 1006, in one embodiment, host processor 600 may encapsulate an I/O read command in accordance with the well-known RDMA protocol. The I/O read command may be placed into an RDMA send queue and become an RDMA_SEND message payload.

At block 1008, the I/O read command, or the RDMA_SEND message, may be formatted in accordance with a data bus protocol, for sending the I/O read command, or the RDMA_SEND message, to host network interface device 212. Such data base protocols include, but are not limited to, PCIe, SATA, SATEe, SAS, eMMC, UFS, PCI, PCI-X, or USB.

At block 1010, the I/O read command, or the RDMA_SEND message, is provided to host network interface device 212 via a local data bus.

At block 1012, the I/O read command, or the RDMA_SEND message, is formatted into one or more data packets by host network interface device 212 in accordance with a wide-area network protocol, such as TCP/IP. The one or more data packets are then sent by host network interface device 212 to target network interface device 214 over wide-area network 206. It should be understood that, typically, the I/O read command, or the RDMA_SEND message, is provided from host network interface device 212 to a local-area network that serves host system 202, and the local-area network provides the I/O write command, or the RDMA_SEND message, as data packets, to wide-area network 206.

At block 1014, the one or more data packets are received by target network interface device 214 via network interface 504. It should be understood that, in some embodiment, the data packets are received by a local-area network that serves target storage server 204, and then the local-area network provides the data packets to target network interface device 214.

At block 1016, processor 500 of target network interface device 214 retrieves the I/O read command from the data packets by unpacking the one or more data packets in accordance with the wide-area network protocol and, in some embodiments, with the RDMA protocol.

At block 1018, processor 500 determines that the data packets comprise an I/O read command by comparing a portion of the received command with a number of commands stored in memory 502, as described earlier.

At block 1020, when processor 500 determines that the data packets comprise an I/O read command, processor 500 determines a local fabric address of the identified data storage device 210 on local fabric 208 based on the identification of the selected data storage device 210 and/or partition information identified by processor 500 in the received I/O read command, as explained above with respect to the I/O write command.

At block 1022, processor 500 generates one or more local fabric data packets representing the I/O read command for transmission over local fabric 208 by fabric interface 506 in accordance with the protocol of local fabric 208. The local fabric data packets each comprise the local fabric address associated with the particular data storage device 210 as determined by processor 500 via the I/O read command and lookup table 508.

At block 1024, one of the data storage devices 210 receives the one or more local fabric data packets via local fabric 208 and fabric interface 804.

At block 1026, data storage controller 800 within the particular data storage device 210 unpacks the one or more local fabric data packets to retrieve the I/O read command including, in some embodiments, a memory start address, an offset, and/or a size of the data. Data storage controller 800 then retrieves the data from mass storage 806, using techniques well known in the art.

At block 1028, data storage controller 800 generates a response to the received I/O read command. The response comprises the data that was requested by host system 202. In one embodiment, the response comprises a response capsule, as defined by the NVM Express over Fabrics, Revision 1.0″ dated Jun. 5. The response is generally formed into one or more local area data packets in accordance with a local fabric protocol and, in some embodiments, with the RDMA protocol.

At block 1030, data storage controller 800 causes the response to be sent to target network interface device 214 via fabric interface 804 and local fabric 208.

At block 1032, processor 500 within target network interface device 214 receives the response via fabric interface 506 and formats it into one or more data packets suitable for transmission over wide-area network 206.

At block 1034, processor 500 sends the one or more data packets to host system 202 via network interface 504 and wide-area network 206, thus providing the data requested by host system 202.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

1. (canceled)

2. (canceled)

3. The network interface device of claim 4, wherein the processor-executable instructions comprise further instructions that cause the network interface device to:
receive, by the processor via the fabric interface, a response from the first data storage device, the response comprising a confirmation that the I/O command was received by the first data storage device; and
send, by the processor via the network interface, the response to the host system via the wide-area network.

4. A network interface device coupled to a target data storage server and to a plurality of data storage devices, for storing data received from a host system over a wide-area network, comprising:
a network interface for receiving data storage commands from the host system over the wide-area network;
a fabric interface coupled to the target data storage server and to the plurality of data storage devices via a local network fabric;
a memory for storing processor-executable instructions:
a processor, coupled to the network interface, the fabric interface and the memory, for executing the processor-executable instructions that causes the network interface device to:
receive, by the network interface, a first data storage command from the host system over the wide-area network;
determine, by the processor, that the first data storage command comprises an I/O command;
forward, by the processor via the fabric interface, the I/O command to a first data storage device of the plurality of data storage devices when the processor determines that the first data storage command comprises an I/O command;
determine, by the processor, that the first data storage command comprises an administrative command;
wherein the processor-executable instructions that cause the network interface device to determine that the first data storage command comprises an administrative command comprises instructions that cause the processor to:
unpack the first data storage command in accordance with a network transport protocol;
compare the first data storage command to a set of commands stored in the memory; and
determine that the first data storage command comprises the I/O command when the first data storage command matches a command to read or write data to one of the data storage devices.

5. A network interface device coupled to a target data storage server and to a plurality of data storage devices, for storing data received from a host system over a wide-area network, comprising:
a network interface for receiving data storage commands from the host system over the wide-area network;
a fabric interface coupled to the target data storage server and to the plurality of data storage devices via a local network fabric;
a memory for storing processor-executable instructions:
a processor, coupled to the network interface, the fabric interface and the memory, for executing the processor-executable instructions that causes the network interface device to:
receive, by the network interface, a first data storage command from the host system over the wide-area network;
determine, by the processor, that the first data storage command comprises an I/O command;
forward, by the processor via the fabric interface, the I/O command to a first data storage device of the plurality of data storage devices when the processor determines that the first data storage command comprises an I/O command;
determine, by the processor, that the first data storage command comprises an administrative command;
provide, by the processor via the fabric interface, the administrative command to the target data storage server when the processor determines that the first data storage command comprises an administrative command;
wherein the processor-executable instructions that cause the network interface device to determine that the first data storage command comprises an administrative command comprises instructions that cause the processor to:
unpack the first data storage command in accordance with a network transport protocol;
compare the first data storage command to a set of commands stored in the memory; and
determine that the first command comprises the administrative command when the first data storage command matches an administrative command stored in the memory.

6. A network interface device coupled to a target data storage server and to a plurality of data storage devices, for storing data received from a host system over a wide-area network, comprising:
a network interface for receiving data storage commands from the host system over the wide-area network;
a fabric interface coupled to the target data storage server and to the plurality of data storage devices via a local network fabric;
a memory for storing processor-executable instructions:
a processor, coupled to the network interface, the fabric interface and the memory, for executing the processor-executable instructions that causes the network interface device to:
receive, by the network interface, a first data storage command from the host system over the wide-area network;
determine, by the processor, that the first data storage command comprises an I/O command;
forward, by the processor via the fabric interface, the I/O command to a first data storage device of the plurality of data storage devices when the processor determines that the first data storage command comprises an I/O command;
determine, by the processor, that the first data storage command comprises an administrative command;
provide, by the processor via the fabric interface, the administrative command to the target data storage server when the processor determines that the first data storage command comprises an administrative command;
wherein the processor-executable instructions that cause the network interface device to determine that the first data storage command comprises an administrative command comprises instructions that cause the processor to:
unpack the first data storage command in accordance with a network transport protocol;
compare the first data storage command to a set of commands stored in the memory; and
determine that the first command comprises the administrative command when the first data storage command matches a fabric command stored in the memory.

7. A network interface device coupled to a target data storage server and to a plurality of data storage devices, for storing data received from a host system over a wide-area network, comprising:
a network interface for receiving data storage commands from the host system over the wide-area network;
a fabric interface coupled to the target data storage server and to the plurality of data storage devices via a local network fabric;
a memory for storing processor-executable instructions:
a processor, coupled to the network interface, the fabric interface and the memory, for executing the processor-executable instructions that causes the network interface device to:
receive, by the network interface, a first data storage command from the host system over the wide-area network;
determine, by the processor, that the first data storage command comprises an I/O command;
forward, by the processor via the fabric interface, the I/O command to a first data storage device of the plurality of data storage devices when the processor determines that the first data storage command comprises an I/O command;
determine, by the processor, that the first data storage command comprises an administrative command;
provide, by the processor via the fabric interface, the administrative command to the target data storage server when the processor determines that the first data storage command comprises an administrative command;
wherein the administrative command comprises a data storage discovery request from the host system for the target data storage server to provide one or more data storage space identifications to the host system, each of the data storage space identifications identifying a particular storage space within one of the plurality of data storage devices coupled to the target data storage server, and the processor-executable instructions comprise further instructions that cause the processor to:
receive, by the processor via the network interface, the data storage discovery request;
determine, by the processor, that the data storage discovery request comprises an administrative command;
in response to determining that the data storage discovery request comprises an administrative command provide, by the processor via the fabric interface, the data storage discovery request to the target data storage server via the fabric interface;
in response to providing the data storage discovery request to the target data storage server, receive, by the processor via the fabric interface, one or more data storage space identifications from the target data storage server; and
provide, by the processor via the network interface, the one or more data storage space identifications to the host system via the wide-area network.

8. A network interface device coupled to a target data storage server and to a plurality of data storage devices, for storing data received from a host system over a wide-area network, comprising:
a network interface for receiving data storage commands from the host system over the wide-area network;
a fabric interface coupled to the target data storage server and to the plurality of data storage devices via a local network fabric;
a memory for storing processor-executable instructions:
a processor, coupled to the network interface, the fabric interface and the memory, for executing the processor-executable instructions that causes the network interface device to:
receive, by the network interface, a first data storage command from the host system over the wide-area network;
determine, by the processor, that the first data storage command comprises an I/O command;
forward, by the processor via the fabric interface, the I/O command to a first data storage device of the plurality of data storage devices when the processor determines that the first data storage command comprises an I/O command;
wherein the I/O command comprises a write command and a data storage space identifier from the one or more data storage space identifications, wherein the processor-executable instructions that cause the network interface device to provide the I/O command to the first data storage device comprises instructions that cause the processor to:
identify, by the processor, a data storage device from the plurality of data storage devices where the storage space is located in accordance with the data storage space identifier; and
provide, by the processor via the fabric interface, the write command to the first data storage device when the storage space is located on the first data storage device.

9. The network interface device of claim 8, wherein the processor-executable instructions that cause the network interface device to identify a data storage device from the plurality of data storage devices where the storage space is located comprises instructions that cause the processor to:
compare the data storage space identifier to data storage space identifiers stored in a lookup table;
retrieve a local fabric address from the lookup table associated with the data storage space identifier;
generate one or more data packets comprising the local fabric address and the write command; and
send the one or more data packets over the local network fabric to the first data storage device via the fabric interface.

10. The network interface device of claim 4, wherein the I/O command comprises a write command and a data storage space identifier that identifies a first storage space within the first data storage device.

11. (canceled)

12. (canceled)

13. The method of claim 14, further comprising:
receiving, by the processor via the fabric interface, a response from the first data storage device, the response comprising a confirmation that the I/O command was received by the first data storage device; and
sending, by the processor via the network interface, the response to the host system via the wide-area network.

14. A method performed by a network interface device for storing data received from a host system over a wide-area network to one or more of a plurality of data storage devices coupled to the network interface device via a local network fabric, the network interface device additionally coupled to a target data storage server via the local network fabric, the method comprising:
receiving, by a network interface, a first data storage command from the host system over the wide-area network;
determining, by the processor, that the first data storage command comprises an I/O command;
providing, by the processor via a fabric interface, the I/O command to a first data storage device of the plurality of data storage devices over the local network fabric when the processor determines that the first data storage command comprises an I/O command;
determining, by the processor, that the first data storage command comprises an administrative command;
providing, by the processor via the fabric interface, the administrative command to the target data storage server over the local network fabric when the processor determines that the first data storage command comprises an administrative command;
wherein determining that the first data storage command comprises an administrative command comprises:
unpacking the first data storage command in accordance with a network transport protocol;
comparing the first data storage command to a set of commands stored in the memory; and
determining that the first data storage command comprises the I/O command when the first data storage command matches a command to read or write data to one of the data storage devices.

15. A method performed by a network interface device for storing data received from a host system over a wide-area network to one or more of a plurality of data storage devices coupled to the network interface device via a local network fabric, the network interface device additionally coupled to a target data storage server via the local network fabric, the method comprising:
receiving, by a network interface, a first data storage command from the host system over the wide-area network;
determining, by the processor, that the first data storage command comprises an I/O command;
providing, by the processor via a fabric interface, the I/O command to a first data storage device of the plurality of data storage devices over the local network fabric when the processor determines that the first data storage command comprises an I/O command;
determining, by the processor, that the first data storage command comprises an administrative command;
providing, by the processor via the fabric interface, the administrative command to the target data storage server over the local network fabric when the processor determines that the first data storage command comprises an administrative command;
wherein determining that the first data storage command comprises an administrative command comprises:
unpacking the first data storage command in accordance with a network transport protocol;
comparing the first data storage command to a set of commands stored in the memory; and
determining that the first command comprises the administrative command when the first data storage command matches an administrative command stored in the memory.

16. A method performed by a network interface device for storing data received from a host system over a wide-area network to one or more of a plurality of data storage devices coupled to the network interface device via a local network fabric, the network interface device additionally coupled to a target data storage server via the local network fabric, the method comprising:
receiving, by a network interface, a first data storage command from the host system over the wide-area network;
determining, by the processor, that the first data storage command comprises an I/O command;
providing, by the processor via a fabric interface, the I/O command to a first data storage device of the plurality of data storage devices over the local network fabric when the processor determines that the first data storage command comprises an I/O command;
determining, by the processor, that the first data storage command comprises an administrative command;
providing, by the processor via the fabric interface, the administrative command to the target data storage server over the local network fabric when the processor determines that the first data storage command comprises an administrative command;
wherein determining that the first data storage command comprises an administrative command comprises:
unpacking the first data storage command in accordance with a network transport protocol;
comparing the first data storage command to a set of commands stored in the memory; and
determining that the first command comprises the administrative command when the first data storage command matches a fabric command stored in the memory.

17. A method performed by a network interface device for storing data received from a host system over a wide-area network to one or more of a plurality of data storage devices coupled to the network interface device via a local network fabric, the network interface device additionally coupled to a target data storage server via the local network fabric, the method comprising:
receiving, by a network interface, a first data storage command from the host system over the wide-area network;
determining, by the processor, that the first data storage command comprises an I/O command;
providing, by the processor via a fabric interface, the I/O command to a first data storage device of the plurality of data storage devices over the local network fabric when the processor determines that the first data storage command comprises an I/O command;
determining, by the processor, that the first data storage command comprises an administrative command;
providing, by the processor via the fabric interface, the administrative command to the target data storage server over the local network fabric when the processor determines that the first data storage command comprises an administrative command;
wherein the administrative command comprises a data storage discovery request from the host system for the target data storage server to provide one or more data storage space identifications to the host system, each of the data storage space identifications identifying a particular storage space within one of the plurality of data storage devices coupled to the target data storage server, further comprising:
receiving, by the processor via the network interface, the data storage discovery request;
determining, by the processor, that the data storage discovery request comprises an administrative command;
in response to determining that the data storage discovery request comprises an administrative command providing, by the processor via the fabric interface, the data storage discovery request to the target data storage server via the fabric interface;
in response to providing the data storage discovery request to the target data storage server, receiving, by the processor via the fabric interface, one or more data storage space identifications from the target data storage server; and
providing, by the processor via the network interface, the one or more data storage space identifications to the host system via the wide-area network.

18. A method performed by a network interface device for storing data received from a host system over a wide-area network to one or more of a plurality of data storage devices coupled to the network interface device via a local network fabric, the network interface device additionally coupled to a target data storage server via the local network fabric, the method comprising:
receiving, by a network interface, a first data storage command from the host system over the wide-area network;
determining, by the processor, that the first data storage command comprises an I/O command; and
providing, by the processor via a fabric interface, the I/O command to a first data storage device of the plurality of data storage devices over the local network fabric when the processor determines that the first data storage command comprises an I/O command;
wherein the I/O command comprises a write command and a data storage space identifier from the one or more data storage space identifications, wherein providing the I/O command to the first data storage device comprises:
identifying, by the processor, a data storage device from the plurality of data storage devices where the storage space is located in accordance with the data storage space identifier; and
providing, by the processor via the fabric interface, the write command to the first data storage device when the storage space is located on the first data storage device.

19. The method of claim 18, wherein identifying a data storage device from the plurality of data storage devices where the storage space is located comprises:
comparing the data storage space identifier to data storage space identifiers stored in a lookup table;
retrieving a local fabric address from the lookup table associated with the data storage space identifier;
generating one or more data packets comprising the local fabric address and the write command; and
sending the one or more data packets over the local network fabric to the first data storage device via the fabric interface.

20. The method of claim 14, wherein the I/O command comprises a write command and a data storage space identifier that identifies a first storage space within the first data storage device.
